(19) United States
(12) Patent Application Publication
(10) Pub. No.: US 2026/0029961 A1
(43) Pub. Date: Jan. 29, 2026

(54) HANDLING OUT-OF-ORDER COMMANDS USING TIMER-BASED COMMAND QUEUE MANAGEMENT

(71) Applicant: Micron Technology, Inc., Boise, ID (US)

(72) Inventor: Giuseppe Cariello, Boise, ID (US)

(21) Appl. No.: 19/265,891

(22) Filed: Jul. 10, 2025

Related U.S. Application Data
(60) Provisional application No. 63/676,808, filed on Jul. 29, 2024.

(51) Int. Cl. G06F 3/06

(52) U.S. Cl. CPC G06F 3/0659; G06F 3/0611; G06F 3/0679

(57) ABSTRACT

Various embodiments described herein provide for handling out-of-order commands by managing a command queue of a memory system based on a timer. In particular, various embodiments stores an out-of-order command in a command queue of a memory system with a pending state that prevents its execution and removal until a missing command preceding (the select command in the sequence of commands) is received and executed by the memory system. For some embodiments, the memory system starts a timer for the out-of-order command and monitors for the expiration of the timer for the out-of-order command. If the timer expires before the missing command is received by the memory system, the memory system can send a response to a host system that causes the host system to restart the sending of the sequence of commands starting from the first command in the sequence.

### PRIORITY APPLICATION

This application claims the benefit of priority to U.S. Provisional Application Ser. No. 63/676,808, filed Jul. 29, 2024, which is incorporated herein by reference in its entirety.

### TECHNICAL FIELD

Embodiments of the disclosure relate generally to memory systems and, more specifically, to managing a command queue of a memory system (such as a memory sub-system) based on a timer to handle out-of-order commands.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIG. 2 illustrates a diagram of an example system that implements a Universal Flash Storage (UFS) specification and in which some embodiments of the present disclosure can be implemented.

FIG. 3A, FIG. 3B, and FIG. 4 are flow diagrams illustrating example methods for managing a command queue of a memory system based on a timer to handle out-of-order commands, in accordance with some embodiments of the present disclosure.

FIG. 5 is a block diagram of an example computer system in which embodiments of the present disclosure may operate.

### DETAILED DESCRIPTION

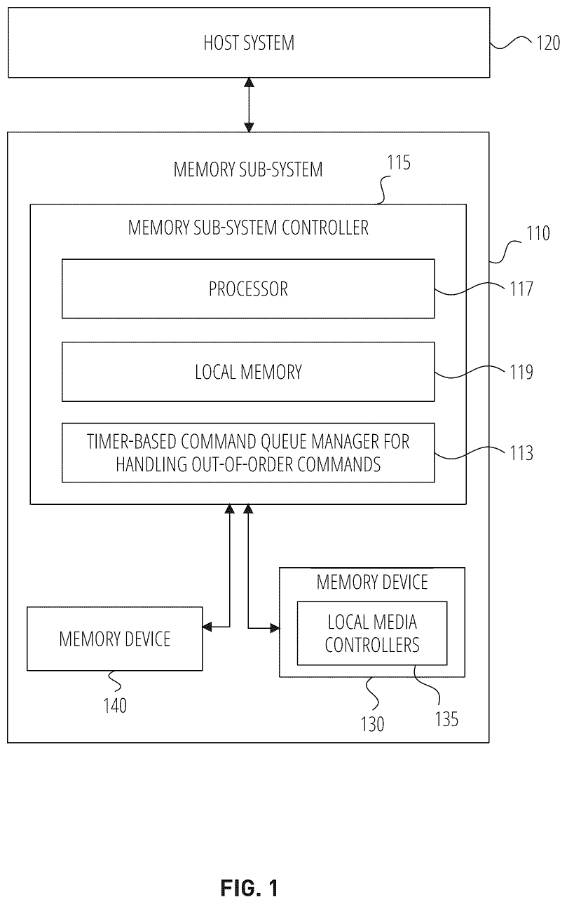

Aspects of the present disclosure are directed to managing a command queue of a memory system (such as a memory sub-system) based on a timer to handle out-of-order commands. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The data can be stored in a memory system (such as a memory sub-system) according to zones. Such a memory system (e.g., memory subs-system) can be referred to as a zone-based memory system (e.g., a zone-based memory sub-system). As used herein, a zone can comprise a contiguous range of logical addresses (e.g., logical block addresses) that is managed within a memory system as a single unit. In comparison to block level data management, a zone-based memory system can use zones to organize and manage data as larger, logically contiguous memory regions, which can allow for more efficient use of storage space on the memory system and reduce write amplification of blocks. Each zone can be managed independently and have an associated state machine maintained by the memory system. The state machine of an individual zone can comprise a set of states for the individual zone, where each state in the set of states (e.g., in combination with and a zone type of the individual zone) can define operational characteristics of the individual zone. Example zone states for an individual zone can include, without limitation: empty; open; closed; full; read-only; or offline. Various zones can be defined in the memory system, each of which can be uniquely associated with a particular set of user data or an application. For example, a first zone can be associated with a first application (or user data identified as received from the first application) and a second zone can be associated with a second application. Host data or user data received from the first application can be stored by the memory system in the first zone. The zones can be of equal or unequal size and can span the size of a single block on a die, multiple blocks on the die, an entire die or a set of dies of the memory system. For example, each zone can span a respective set of blocks in a corresponding die or set of die rather than sequentially across a row of blocks, and a particular application can be associated with a given zone that spans a single die. User or host data associated with that application can be stored in that given zone on the single die. A zone can be defined in a memory system in accordance with a memory specification, such as Zoned Universal Flash Storage (zUFS) or the like.

The memory sub-system can initiate media management operations, such as a write operation, on host data that is stored on a memory device. For example, firmware of the memory sub-system may re-write previously written host data from a location of a memory device to a new location as part of a garbage collection management operation (or garbage collection process). The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as a L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package. The memory device can be divided into one or more zones where each zone is associated with a different set of host data or user data or application.

Certain memory devices, such as NAND-type memory devices, comprise one or more blocks, (e.g., multiple blocks), with each of those blocks comprising multiple memory cells. For instance, a memory device can comprise multiple pages (also referred to as wordlines), with each page comprising a subset of memory cells of the memory device. A threshold voltage (VT) of a memory cell (of a block) can be the voltage at which the floating gate (e.g., NAND transistor), implementing the memory cell, turns on and conducts (e.g., to a bit line coupled to the memory cell). Generally, writing data to such memory devices involves programming (by way of a program operation) the memory devices at the page level of a block, and erasing data from such memory devices involves erasing the memory devices at the block level (e.g., page level erasure of data is not possible).

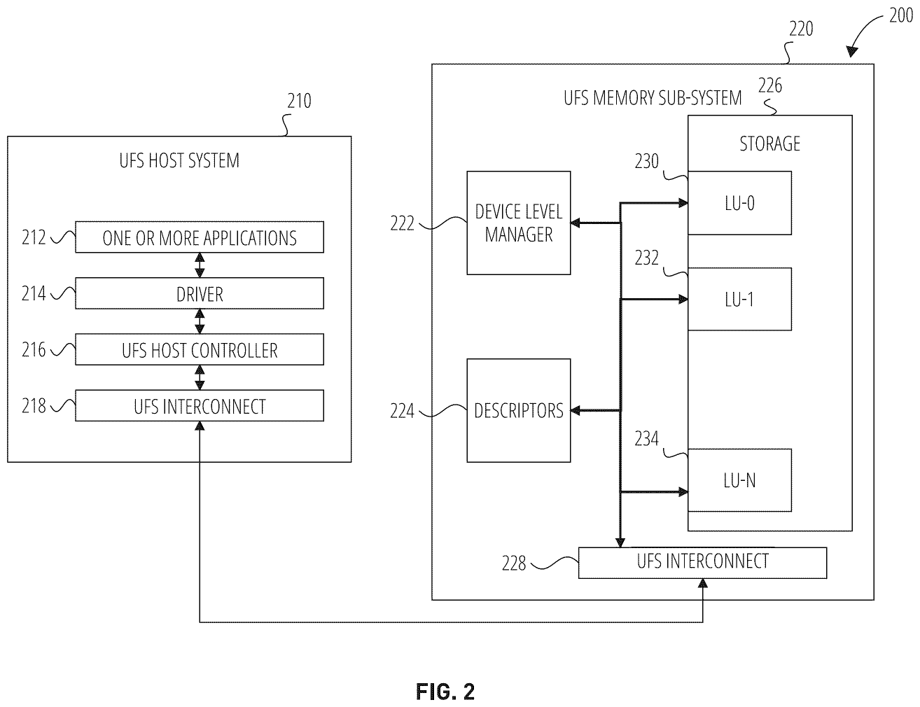

UFS is a flash storage specification for electronic devices (e.g., mobile devices) that is promulgated by the Joint Electron Device Engineering Council (JEDEC) solid-state technology association. Zoned UFS (zUFS) is a version of the UFS specification that supports zones. A memory system (e.g., memory sub-system) that implements UFS communicates with a host system using a serial communication interface (rather than a parallel communication interface), where the serial communication interface comprises a low-voltage differential signaling (LVDS) serial interface with dedicated read/write paths that advance read/write speeds between the memory device sub-system and the host system. An example of a memory system implementing a UFS specification is illustrated and described with respect to FIG. 2.

For memory systems that implement a UFS specification and the like, the management of command sequences (e.g., sequences of commands received from a host system) in the memory systems can ensure performance and reliability. Generally, a UFS specification describes how commands received from a host system are handled and processed in a sequential order. Sequentiality of commands on a memory system can ensure efficient data handling and can minimize the risk of data corruption or loss on the memory system.

Unfortunately, in practical scenarios, the ideal sequence of command processing can be disrupted due to various factors. For example, while certain memory system specifications (such as a zUFS specification, which is a UFS specification that supports zones) have an expectation that sequentiality of receiving and processing host write commands will be maintained, a host system cannot guarantee the sequentiality due to unsynchronized paths in the software stack of the host system. Such unsynchronized paths can lead to out-of-order delivery of commands (e.g., write commands) from the host system to the memory system even though those commands were generated in a sequential order on the host system. This discrepancy can arise because different components or layers of the software stack can process commands at varying speeds, leading to a mismatch in the order in which commands are sent from the host system to the memory system. Generally, a memory system uses a command queue queues commands received from a host system for execution on the memory system, and begins to reject commands received from the host system when the command queue is full (e.g., the maximum depth of the command queue has been reached). One conventional solution to address the issue of out-of-order delivery of commands from the host system is to reduce a depth of the command queue of the memory system to one (to ensure that commands are processed one at a time and in the order that the commands are received). This approach, however, can significantly impact the memory system's performance, as it limits the throughput and efficiency of command processing within the memory system.

Another conventional solution can be to reorder commands at the memory system, which is permitted by UFS specifications and can be extended to zoned UFS. By reordering commands, the memory system can adjust the sequence of command execution without waiting for commands to arrive in the originally intended order; such a capability can be useful in maintaining system performance and avoiding delays that could lead to a deadlock on the memory system. A deadlock can refer to a situation where a memory system becomes completely unresponsive due to waiting for a command from a host system that either cannot be executed by the memory system due to its position in a sequence of commands or is delayed in arrival. To prevent such scenarios, a memory system can implement a fixed depth for a command queue of the memory system. When the command queue is full, the memory system might keep out-of-order commands (in the command queue) in a pending state until there is room in the command queue to process them, or it might reject (e.g., remove) older commands in the command queue to make space in the command queue for new ones. This approach, however, carries the risk of causing further delays and potential memory system deadlocks if the host system reissues the rejected command before one or more missing commands (that the memory system is waiting for) are received by the memory system from the host system.

Various embodiments described herein cure or address these and other deficiencies of conventional memory systems. In particular, various embodiments implement one or more techniques for efficiently managing command queues to increase the performance of a memory system, such as a memory sub-system, while avoiding deadlock situations on the memory system. For instance, an example embodiment herein can involve maintaining a fixed command queue depth (QD) on a memory system and storing out-of-order commands in the command queue in a pending state while they wait for missing commands to be received. An example embodiment described herein can comprise implementation of a timeout policy for out-of-order commands that remain in the command queue (in the pending state) for too long without being executed. The timeout policy can ensure that timed-out out-of-order commands in the memory system do not result in deadlock on the memory system by causing the host system to restart the sending of the sequence of commands from the beginning. By causing the host system to restart the sequence of commands, the memory system can ensure (or at least expect) that the missing command (that a timed-out out-of-order command is waiting for) will be resent by the host system. Additionally, if the out-of-order commands are resubmitted by the host system, a memory system can immediately reject the out-of-order commands from the command queue.

According to some embodiments, a memory system (e.g., memory sub-system) implements timer-based management of a command queue for handling out-of-order commands. A memory system of various embodiments receives, from a host system, a select command (e.g., write command) out of order with respect to a sequence of commands (e.g., sequence of write commands for a zone defined) on the memory system. The command queue of the memory system can be fixed in size or depth. For some embodiments, the memory system stores the select command in the command queue with a pending state that prevents its execution and removal until a missing command preceding (the select command in the sequence of commands) is received and executed by the memory system. In this way, where the select command comprises a write command (e.g., to write data from logic block address (LBA) 100 to 199) in a sequence of write commands (e.g., with write commands to write from LBA 0 to 1000), execution of the select command can wait for a preceding write command (e.g., to write data from LBA 0 to 99) to be executed, thereby ensuring data is written sequentially (e.g., to a zone associated with the sequence of write commands) according to the sequence in which the write commands were generated by the host system (e.g., software stack of the host system). For some embodiments, the memory system starts a timer (e.g., an internal timer of the memory system) for the select command and monitors for the expiration of the timer for the select command (e.g., according to a timeout policy, where the expiration of a timer indicates that the select command has timed out). If the timer expires before the missing command (that the select command is waiting for) is received by the memory system, the memory system can send a response (e.g., an error, fail, or abort response) to the host system that causes (e.g., prompts) the host system to restart the sending of the sequence of commands starting from the first command in the sequence. By sending the response to the host system to cause the host system to restart the sequence of commands, the memory system can ensure (or at least expect) that the missing command (that the select command is waiting for) will be resent by the host system. For example, the response can comprise an error, fail or abort response for an individual command last received by the memory system (e.g., and stored in the command queue to facilitate execution) in connection with the sequence of commands. Additionally, if the individual command is already stored in the command queue, the memory system can remove (or cause the removal of) the individual command from the command queue, thereby freeing up space (e.g., freeing up a slot) in the command queue to receive the missing command that is causing the select command to be in the pending state. With the use of a timer, a memory system of various embodiments can avoid having to wait for the command queue to be full prior to rejecting or aborting commands sent from the host system when at least one command in the command queue is in the pending state. The timer's duration can be set according to a policy (e.g., timeout policy) or a parameter, where the policy/parameter can be determined or adjusted based on a value provided by the host system or dynamically determined or adjusted by the memory system based on a performance metric of the memory system (e.g., command throughput of the memory system). In doing so, the memory system can provide operational flexibility.

For some embodiments, the memory system comprises local memory (e.g., SRAM, which the memory system can use in executing operations on the memory system according to firmware), and data space is reserved on the local memory for executing any missing command that at least one command in the command queue with the pending state is waiting for. In this way, reserving data space on the local memory can be used for executing any missing commands, thereby optimizing memory usage and command processing efficiency. Additionally, for some embodiments, a host system is configured to limit the maximum depth of the host system's one or more command queues to not exceed the maximum depth of the memory system's command queue. In doing so, various embodiments can help prevent deadlock in the memory system.

While various embodiments are described here with respect to UFS (e.g., zUFS specification), for some embodiments, the disclosed improvements are implemented with other memory specifications (e.g., non-UFS specifications).

Disclosed herein are some examples of managing a command queue of a memory system (e.g., memory sub-system) based on a timer to handle out-of-order commands, as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single-level cells (SLCs), can store one bit per cell. Other types of memory cells, such as multiple-layer cells (MLCs), triple-layer cells (TLCs), quad-level cells (QLCs), and penta-level cells (PLCs), can store multiple bits per cell. In some embodiments, each of the memory devices 130, 140 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and ECC operations, encryption operations, caching operations, and address translations between a logical address (e.g., LB A, namespace) and a physical memory address (e.g., physical block address) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some embodiments, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

The memory sub-system controller 115 includes a timer-based command queue manager for handling out-of-order commands 113 (hereafter, the timer-based command queue manager 113) that enables or facilitates the memory sub-system controller 115 to handle out-of-order commands by managing a command queue of the memory sub-system 110 based on a timer in accordance with various embodiments described herein. Alternatively, some or all of the timer-based command queue manager 113 is included by the local media controller 135, thereby enabling the local media controller 135 handle out-of-order commands by managing a command queue of the memory sub-system 110 based on a timer.

FIG. 2 illustrates a diagram of an example system 200 that implements a UFS specification and in which some embodiments of the present disclosure can be implemented. As shown, the system 200 comprises a Universal Flash Storage (UFS) host system 210 that implements the UFS specification and a Universal Flash Storage (UFS) memory sub-system 220 that implements the UFS specification. The UFS host system 210 can represent an entity or a device with the characteristics of a computing device that includes one or more initiator devices. In some examples, the UFS host system 210 can be an application processor of the electronic device. Initiator devices (initiators) are devices or processes that initiate a UFS transaction to a target device and are identified by an Initiator ID (IID). For example, different processes (e.g., operating systems) can each have a unique IID, a radio portion of a phone might have a unique IID and the like.

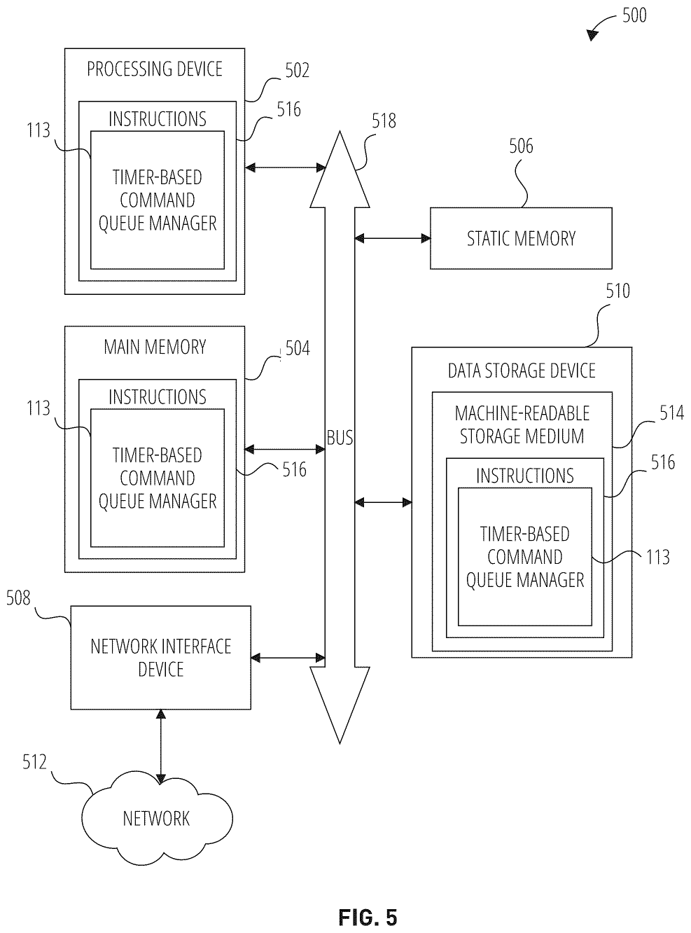

The UFS host system 210 can execute one or more applications 212 that read or write data to the UFS memory sub-system 220. The one or more applications 212 interface with a driver 214 that manages the UFS host controller 216 through a UFS Host Controller Interface using a set of registers. Registers can be volatile memory, non-volatile memory, or any combination and can be a temporary storage location that is used by the UFS host controller 216. The UFS host controller 216 uses the UFS interconnect 218 to communicate with a UFS interconnect 228 of the UFS memory sub-system 220. The UFS memory sub-system 220 is a target device (e.g., receives UFS commands). An electronic device, such as a mobile device, can comprise both the UFS host system 210 and the UFS memory sub-system 220. The UFS interconnect can comprise a physical (PHY) layer and can provide basic transfer capabilities to the upper layers. The UFS interconnect 228 communicates with the components of the UFS memory sub-system 220. While the UFS host system 210 and the UFS memory sub-system 220 can be part of an electronic device, in other examples, the UFS host system 210 can be an application-specific integrated circuit (ASIC), or one or more other microprocessors designed to act as an interface the UFS memory sub-system 220. In some examples, the one or more applications 212, the driver 214, the UFS host controller 216, and the UFS interconnect 218 can be implemented in hardware or software (e.g., be implemented as machine-readable instructions that are performed by a hardware processor such as the processing device 502 of FIG. 5).

The UFS memory sub-system 220 features a device level manager 222 that provides for device level features such as power management, and the like (which can be executed by a memory sub-system controller, such as memory sub-system controller 115 of FIG. 1). Descriptors 224 store configuration related information. Storage 226 can be one or more NAND-type memory devices (e.g., memory devices 130, 140 of FIG. 1) segmented into a plurality of Logical Unit (LU) s 0-N (230, 232, 234 respectively), which can handle read/write and other storage related commands. For example, the UFS memory sub-system 220 can be configured as 4 LUs of 4 GB each. Each memory device die on a memory device can be a LUN. Storage 226 can be an example organization of cells of a NAND-type memory device die. the device level manager 222, the descriptors 224, and the UFS interconnect 228 can be implemented by one or more hardware processors (e.g., memory sub-system controller 115 of FIG. 1).

According to various embodiments, methodologies for managing a command queue of a memory system based on a timer to handle out-of-order commands can be implemented within the system 200. For instance, the device level manager 222 of the UFS memory sub-system 220 could implement some or all of the timer-based command queue manager 113 illustrated and described with respect to FIG. 1.

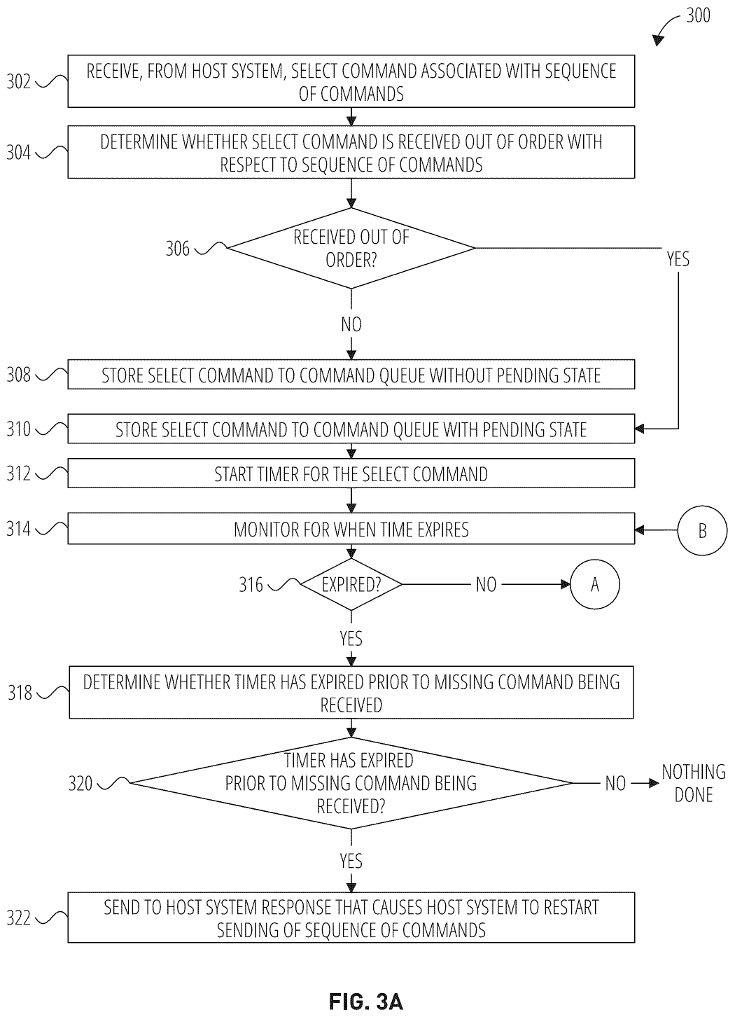

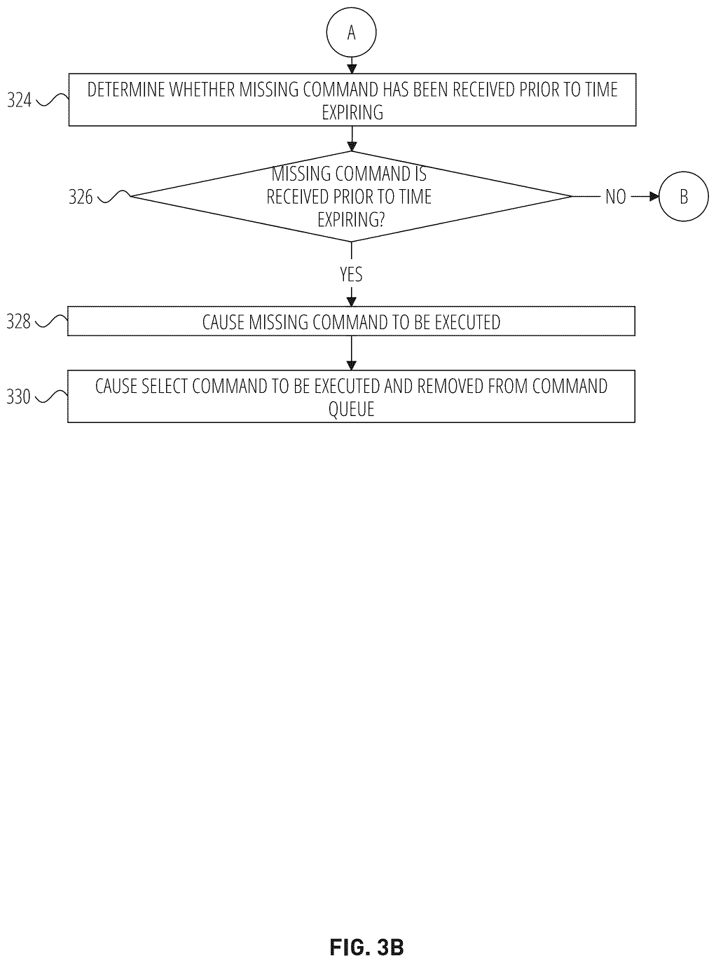

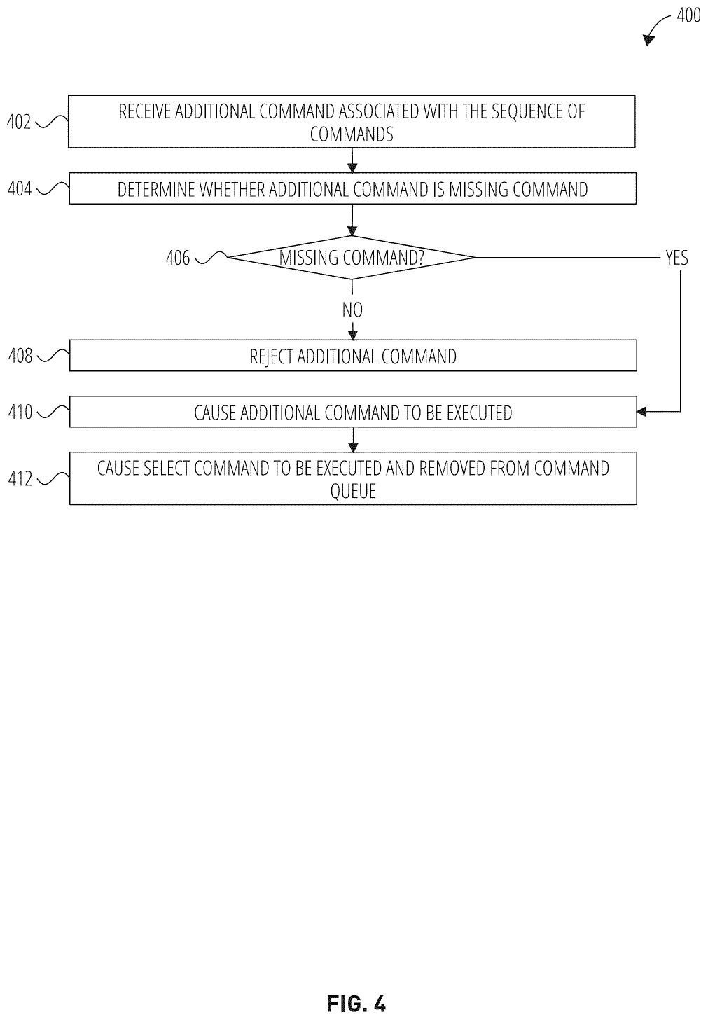

FIG. 3A, FIG. 3B, and FIG. 4 are flow diagrams illustrating example methods 300, 400 for managing a command queue of a memory system (e.g., memory sub-system) based on a timer to handle out-of-order commands, in accordance with some embodiments of the present disclosure. Any of methods 300, 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, any of methods 300, 400 is performed by the memory sub-system controller 115 of FIG. 1 based on the timer-based command queue manager 113. Additionally, or alternatively, for some embodiments, any of methods 300, 400 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

Referring now to the method 300 of FIG. 3A, at operation 302 a processing device (e.g., the processor 117 of the memory sub-system controller 115) receives, from a host system (e.g., 120), a select command associated with a sequence of commands. For various embodiments, the sequence of commands is associated with a zone defined on a memory system (e.g., memory sub-system 110). For instance, the zone could be defined in accordance with a zUFS specification. Additionally, for various embodiments, the select command is a write command (e.g., for data to be written to a zone) and the sequence of commands comprises a sequence of write commands (e.g., for writing data sequentially to the zone).

After operation 302, at operation 304, the processing device (e.g., the processor 117 of the memory sub-system controller 115) determines whether the select command is received out of order with respect to the sequence of commands. At decision block 306, in response to determining that the select command is not out of order with respect to the sequence of commands, the method 300 proceeds to operation 308, where the processing device stores the select command to a command queue (e.g., at the end of the command queue) of a memory system (e.g., memory sub-system 110) without a pending state (e.g., either with no state or with a read-for-execution state), thereby enabling the select command to be executed and removed from the command queue when the select command reaches the front of the command queue. Alternatively, at decision block 306, in response to determining that the select command is out of order with respect to the sequence of commands, the method 300 proceeds to operation 310.

At operation 310, the processing device (e.g., the processor 117 of the memory sub-system controller 115) stores the select command to the command queue (e.g., at the end of the command queue) with a pending state that prevents execution of the select command and removal of the select command from the command queue until the memory system (e.g., memory sub-system 110) receives and executes a missing command that precedes the select command in the sequence of commands. By applying the pending state, the select command can remain in the command queue and wait for the missing command to execute prior to the select command being executed, even if the select command reaches the front of the command queue. Additionally, at operation 310, the processing device starts a timer for (e.g., in association with) the select command. Depending on the embodiment, the timer can comprise an internal timer of the memory system, the timer can be set to expire after a set duration of time, and the timer can be a countdown timer. When a timer expires (based on its duration), an expiration or timeout response or signal can be generated on the memory system. The duration of the timer can be determined based on a policy or a parameter (e.g., user-defined parameter). For example, the policy can be a timeout policy, where the select command is considered timed out after the time expires. For various embodiments, the duration of the timer is set to a value (e.g., 100 milliseconds) that is less than a command timeout period (e.g., 1 second) that is being used by the host system (e.g., a timeout value for when the host system clears one or more of its command queues and restarts the sending of the sequence of commands). Additionally, the policy or the parameter can be determined or adjusted based on a value provided by the host system (e.g., via a command) or dynamically determined or adjusted by the memory system based on a performance metric of the memory system (e.g., command throughput of the memory system).

After operation 312, at operation 314, the processing device (e.g., the processor 117 of the memory sub-system controller 115) monitors for when the timer expires (e.g., for when the timer generates a timeout/expiration response). At decision block 316, if the timer has not expired, the method 300 proceeds to operation 324 (on FIG. 3B) and, if the time has expired, the method 300 proceeds to operation 318.

At operation 318, the processing device (e.g., the processor 117 of the memory sub-system controller 115) determines whether the timer has expired prior to the missing command (for which the select command is waiting) being received (e.g., and stored in the command queue to facilitate execution). At s 320, if the timer does not expire prior to the missing command being received (e.g., and stored in the command queue to facilitate execution), nothing is done as the missing command that the select command was waiting for has been received. However, at s 320, in response determining that the timer has expired prior to the missing command being received (e.g., and stored in the command queue to facilitate execution), the method 300 proceeds to operation 322, where the processing device sends a response to the host system (e.g., 120) that causes the host system to restart the sending of the sequence of commands from the beginning (e.g., from a first command in the sequence of commands). By sending the response to the host system to cause the host system to restart the sequence of commands, the memory system can ensure (or at least expect) that the missing command (that the select command is waiting for) will be resent by the host system. The response can cause the host system (e.g., 120) to clear one or more of its command queues to enable the host system to restart the sending of the sequence of commands. For some embodiments, the response comprises an error response for (e.g., associated with) an individual command, in the command queue, that was last received for the sequence of commands. For example, if the select command (with pending state) is the second command, and the command queue also stores the third command and the fourth command in the sequence of commands, then the fourth command can represent the last command for which an error response is sent by the memory system (e.g., memory sub-system 110). Depending on the embodiment, the response can comprise an out-of-order error response for the individual command. As part of operation 322, the processing device can remove (or cause removal of) the individual command from the command queue. In doing so, various embodiments can free up space (e.g., at least one command slot) in the command queue to store and execute the missing command that the select command is waiting for. After operation 322, for some embodiments, the processing device performs the method 400 illustrated and described with respect to FIG. 4.

Referring now to FIG. 3B, at operation 324, the processing device (e.g., the processor 117 of the memory sub-system controller 115) determines whether the missing command (that the select command is waiting for) has been received by the memory system (e.g., and stored in the command queue to facilitate execution) prior to the timer expiring. At decision block 326, in response to the missing command not being received by the memory system prior to the timer expiring, the method 300 returns to operation 314, where the processing device continues to monitor for when the timer expires. Alternatively, at decision block 326, in response to the missing command being received by the memory system prior to the timer expiring, the method 300 proceeds to operation 328, where the processing device causes the missing command to be executed. For example, if the missing command is stored in the command queue after being received, the processing device can cause the missing command to be executed by causing the command queue to be reordered such that the missing command (and not the command that is currently at the front of the command queue) is the next command to be executed by the processing device. If the missing command is stored in the command queue prior to execution, after the missing command is executed, the processing device can remove (or cause the removal of) the missing command from the command queue. After the missing command is executed, at operation 330, the processing device causes the select command to be executed and removed from the command queue. For some embodiments, operation 330 comprises the processing device removing the pending state from the select command, which can render the select command ready for execution when the select command reaches the front of the command queue.

Referring now to FIG. 4, the method 400 can be performed after a processing device (e.g., the processor 117 of the memory sub-system controller 115) sends a response (e.g., error response) to a host system that causes the host system to restart sending of a sequence of commands (at operation 322 of the method 300). For some embodiments, the method 400 is performed to handle situations where a response has already been sent to a host system (to cause it to restart sending a sequence of commands) but there is a lag in the host system restarting the sending of the sequence of command and, as a result, the memory system (e.g., memory sub-system 110) continues to receive from the host system remnant commands from the prior send.

At operation 402, the processing device (e.g., the processor 117 of the memory sub-system controller 115) receives an additional command associated with the sequence of commands. For operation 404, the processing device determines whether the additional command is the missing command that the select command is waiting for.

At decision block 406, in response to the additional command being the missing command, the method 400 proceeds to operation 408, the method 400 proceeds to operation 410. Alternatively, at decision block 406, in response to the additional command not being the missing command, the method 400 proceeds to operation 408, where the processing device rejects the additional command. In rejecting the additional command, the processing device can prevent the additional command from being stored in the command queue (for execution) and can ensure that free space (e.g., at least one slot) is preserved in the command queue for storage and execution of the missing command once the missing command is received by the memory system (e.g., memory sub-system 110).

At operation 410, the processing device (e.g., the processor 117 of the memory sub-system controller 115) causes the additional command to be executed. For example, if the additional command is stored in the command queue after being received, the processing device can cause the additional command to be executed by causing the command queue to be reordered such that the additional command (and not the command that is currently at the front of the command queue) is the next command to be executed by the processing device. If the additional command is stored in the command queue prior to execution, after the additional command is executed, the processing device can remove (or cause the removal of) the additional command from the command queue. After the additional command is executed, at operation 412, the processing device causes the select command to be executed and removed from the command queue. For some embodiments, operation 412 comprises the processing device removing the pending state from the select command, which can render the select command ready for execution when the select command reaches the front of the command queue.

For some embodiments, the memory system (e.g., memory sub-system 110) comprises local memory (e.g., local memory 119) and the processing device causes data space to be reserved on the local memory for executing any missing command that at least one command in the command queue with the pending state is waiting for. For example, for a memory system that implements a UFS specification, such as a zUFS specification, a Write Cache Enable (WCE) is set for a Logical Unit Number (LUN), which can enable the processing device to complete out-of-order commands or missing commands by receiving the data for those commands in the local memory of the memory system. To prevent deadlocks, the memory system can reserve a minimal buffer space in the local memory to permit incoming data to transit from the host system to the memory system.

FIG. 5 illustrates an example machine in the form of a computer system 500 within which a set of instructions can be executed for causing the machine to perform any one or more of the methodologies discussed herein. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or Rambus DRAM (RDRAM), etc.), a static memory 506 (e.g., flash memory, static random access memory (SRAM), etc.), and a data storage device 510, which communicate with each other via a bus 518.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application-specific integrated circuit (ASIC), a field programmable gate array (FPGA), a digital signal processor (DSP), a network processor, or the like. The processing device 502 is configured to execute instructions 516 for performing the operations and steps discussed herein. The computer system 500 can further include a network interface device 508 to communicate over a network 512.

The data storage device 510 can include a machine-readable storage medium 514 (also known as a computer-readable medium) on which is stored one or more sets of instructions 516 or software embodying any one or more of the methodologies or functions described herein. The instructions 516 can also reside, completely or at least partially, within the main memory 504 and/or within the processing device 502 during execution thereof by the computer system 500, the main memory 504 and the processing device 502 also constituting machine-readable storage media. The machine-readable storage medium 514, data storage device 510, and/or main memory 504 can correspond to the memory sub-system 110 of FIG. 1.

In one embodiment, the instructions 516 include instructions to implement functionality corresponding to managing a command queue of a memory system based on a timer to handle out-of-order commands as described herein (e.g., the timer-based command queue manager 113 of FIG. 1). While the machine-readable storage medium 514 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1 is a memory system comprising: a memory device; a command queue for commands received from a host system, the command queue having a fixed depth; and a processing device, operatively coupled to the memory device, configured to perform operations comprising: receiving, from the host system, a select command associated with a sequence of commands; determining whether the select command is received out of order with respect to the sequence of commands; and in response to determining that the select command is out of order with respect to the sequence of commands: storing the select command to the command queue with a pending state, the pending state preventing execution of the select command and removal of the select command from the command queue until the memory system receives and executes a missing command that precedes the select command in the sequence of commands; starting a timer for the select command; and in response to the timer expiring prior to the missing command being received by the memory system, sending to the host system a response that causes the host system to restart sending of the sequence of commands from a first command in the sequence of commands.

In Example 2, the subject matter of Example 1 includes, wherein the operations comprise: monitoring for when the timer expires; and in response to the timer expiring, determining whether the timer has expired prior to the missing command being received by the memory system.

In Example 3, the subject matter of Examples 1-2 includes, wherein the response comprises an error response for an individual command, in the command queue, that was last received for the sequence of commands, and wherein the operations comprise: removing the individual command from the command queue.

In Example 4, the subject matter of Examples 1-3 includes, wherein the operations comprise: in response the missing command being received by the memory system prior to the timer expiring: causing the missing command to be executed; and after the missing command is executed, causing the select command to be executed and removed from the command queue.

In Example 5, the subject matter of Example 4 includes, wherein the causing of the select command to be executed and removed from the command queue comprises: removing the pending state from the select command.

In Example 6, the subject matter of Examples 4-5 includes, wherein the missing command is stored in the command queue prior to execution of the missing command, and wherein the missing command is removed from the command queue after execution of the missing command.

In Example 7, the subject matter of Examples 1-6 includes, wherein the select command comprises a write command, and the sequence of commands comprises a set of write commands.

In Example 8, the subject matter of Examples 1-7 includes, wherein the operations comprise: after the sending of the response: receiving an additional command associated with the sequence of commands; determining whether the additional command is the missing command; and in response to determining that the additional command is not the missing command, rejecting the additional command.

In Example 9, the subject matter of Examples 1-8 includes, wherein the operations comprise: after the sending of the response: receiving an additional command associated with the sequence of commands; determining whether the additional command is the missing command; and in response to determining that the additional command is the missing command: causing the additional command to be executed; and after the additional command is executed, causing the select command to be executed and removed from the command queue.

In Example 10, the subject matter of Example 9 includes, wherein the causing of the select command to be executed and removed from the command queue comprises: removing the pending state from the select command.

In Example 11, the subject matter of Examples 9-10 includes, wherein the additional command is stored in the command queue prior to execution of the additional command, and wherein the additional command is removed from the command queue after execution of the additional command.

In Example 12, the subject matter of Examples 1-11 includes, wherein the memory system supports zones, and wherein the sequence of commands is associated with a select zone defined on the memory system.

In Example 13, the subject matter of Example 12 includes, wherein the memory system operates in accordance with a zone Universal Flash Storage (zUFS) specification.

In Example 14, the subject matter of Examples 1-13 includes, wherein operations comprise: determining whether the command queue is full and the select command remains in the command queue with the pending state, rejecting a last command received by the command queue.

In Example 15, the subject matter of Examples 1-14 includes, wherein a duration of the timer is than a command timeout period of the host system.

In Example 16, the subject matter of Examples 1-15 includes, wherein a duration of the timer is set based on a parameter value received from the host system.

In Example 17, the subject matter of Examples 1-16 includes, wherein the memory system comprises local memory, and wherein data space is reserved on the local memory for executing any missing command that at least one command in the command queue with the pending state is waiting for.

In Example 18, the subject matter of Examples 1-17 includes, wherein the operations comprise: in response to determining that the select command is not out of order with respect to the sequence of commands, storing the select command to the command queue without the pending state.

Example 19 is a method to implement any of Examples 1-18.

Example 20 is at least one machine-readable medium comprising instructions that, when executed by a processing device, cause the processing device to perform operations to implement any of Examples 1-18.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A memory system comprising:
a memory device;
a command queue for commands received from a host system, the command queue having a fixed depth; and
a processing device, operatively coupled to the memory device, configured to perform operations comprising:
receiving, from the host system, a select command associated with a sequence of commands;
determining whether the select command is received out of order with respect to the sequence of commands; and
in response to determining that the select command is out of order with respect to the sequence of commands:
storing the select command to the command queue with a pending state, the pending state preventing execution of the select command and removal of the select command from the command queue until the memory system receives and executes a missing command that precedes the select command in the sequence of commands;
starting a timer for the select command; and
in response to the timer expiring prior to the missing command being received by the memory system, sending to the host system a response that causes the host system to restart sending of the sequence of commands from a first command in the sequence of commands.

2. The memory system of claim 1, wherein the operations comprise:
monitoring for when the timer expires; and
in response to the timer expiring, determining whether the timer has expired prior to the missing command being received by the memory system.

3. The memory system of claim 1, wherein the response comprises an error response for an individual command, in the command queue, that was last received for the sequence of commands, and wherein the operations comprise:
removing the individual command from the command queue.

4. The memory system of claim 1, wherein the operations comprise:
in response the missing command being received by the memory system prior to the timer expiring:
causing the missing command to be executed; and
after the missing command is executed, causing the select command to be executed and removed from the command queue.

5. The memory system of claim 4, wherein the causing of the select command to be executed and removed from the command queue comprises:
removing the pending state from the select command.

6. The memory system of claim 4, wherein the missing command is stored in the command queue prior to execution of the missing command, and wherein the missing command is removed from the command queue after execution of the missing command.

7. The memory system of claim 1, wherein the select command comprises a write command, and the sequence of commands comprises a set of write commands.

8. The memory system of claim 1, wherein the operations comprise:
after the sending of the response:
receiving an additional command associated with the sequence of commands;
determining whether the additional command is the missing command; and
in response to determining that the additional command is not the missing command, rejecting the additional command.

9. The memory system of claim 1, wherein the operations comprise:
after the sending of the response:
receiving an additional command associated with the sequence of commands;
determining whether the additional command is the missing command; and
in response to determining that the additional command is the missing command:
causing the additional command to be executed; and
after the additional command is executed, causing the select command to be executed and removed from the command queue.

10. The memory system of claim 9, wherein the causing of the select command to be executed and removed from the command queue comprises:
removing the pending state from the select command.

11. The memory system of claim 9, wherein the additional command is stored in the command queue prior to execution of the additional command, and wherein the additional command is removed from the command queue after execution of the additional command.

12. The memory system of claim 1, wherein the memory system supports zones, and wherein the sequence of commands is associated with a select zone defined on the memory system.

13. The memory system of claim 12, wherein the memory system operates in accordance with a zone Universal Flash Storage (zUFS) specification.

14. The memory system of claim 1, wherein operations comprise:
determining whether the command queue is full and the select command remains in the command queue with the pending state, rejecting a last command received by the command queue.

15. The memory system of claim 1, wherein a duration of the timer is than a command timeout period of the host system.

16. The memory system of claim 1, wherein a duration of the timer is set based on a parameter value received from the host system.

17. The memory system of claim 1, wherein the memory system comprises local memory, and wherein data space is reserved on the local memory for executing any missing command that at least one command in the command queue with the pending state is waiting for.

18. The memory system of claim 1, wherein the operations comprise:
in response to determining that the select command is not out of order with respect to the sequence of commands, storing the select command to the command queue without the pending state.

19. At least one non-transitory machine-readable storage medium comprising instructions that, when executed by a processing device of a memory sub-system, cause the processing device to perform operations comprising:
receiving, from a host system, a select command associated with a sequence of commands;
determining whether the select command is received out of order with respect to the sequence of commands; and
in response to determining that the select command is out of order with respect to the sequence of commands:
storing the select command to a command queue of the memory sub-system, the select command being stored with a pending state that prevents execution of the select command and removal of the select command from the command queue until the memory sub-system receives and executes a missing command that precedes the select command in the sequence of commands;
starting a timer for the select command; and
in response to the timer expiring prior to the missing command being received by the memory sub-system, sending to the host system a response that causes the host system to restart sending of the sequence of commands from a first command in the sequence of commands.

20. A method comprising:
receiving, at a memory sub-system, a select command from a host system, the select command being associated with a sequence of commands;
determining, by a memory sub-system controller of the memory sub-system, that the select command is received out of order with respect to the sequence of commands; and
in response to determining that the select command is out of order with respect to the sequence of commands:
storing, by the memory sub-system controller, the select command to a command queue of the memory sub-system, the select command being stored with a pending state that prevents execution of the select command and removal of the select command from the command queue until the memory sub-system receives and executes a missing command that precedes the select command in the sequence of commands;
starting, by the memory sub-system controller, a timer for the select command; and
in response to the timer expiring prior to the missing command being received by the command queue, sending, from the memory sub-system to the host system, a response that causes the host system to restart sending of the sequence of commands from a first command in the sequence of commands.
